(19) United States
(12) Patent Application Publication
(10) Pub. No.: US 2012/0120024 A1
(43) Pub. Date: May 17, 2012

(54) TOUCH SYSTEM AND OPTICAL TOUCH SYSTEM WITH POWER-SAVING MECHANISM

(75) Inventors: Yu-Chia Lin, Hsinchu County (TW); Tzung-Min Su, Hsinchu County (TW); Cheng-Nan Tsai, Hsinchu County (TW); Chih-Hsin Lin, Hsinchu County (TW); Teng-Wei Hsu, Hsinchu County (TW); Yuan-Yu Peng, Hsinchu County (TW); Chuan-Ching Lin, Hsinchu County (TW)

(73) Assignee: PixArt Imaging Inc., Hsinchu County (TW)

(21) Appl. No.: 13/155,197

(22) Filed: Jun. 7, 2011

(30) Foreign Application Priority Data
Nov. 17, 2010 (TW) 099139609

(51) Int. Cl. G06F 3/042; G06F 3/041

(52) U.S. Cl. 345/175; 345/173

(57) ABSTRACT

A touch system and an optical touch system with a power-saving mechanism are presented. The touch system includes a sensing module and a processing module electrically connected to the sensing module; the optical touch system includes an optical sensing module and a processing module electrically connected to the optical sensing module. The processing module modulates a working frequency and/or a working voltage of the processing module according to a touch point count on a touch region, a preset function of the processing module, and/or an imaging count detected by the optical sensing module, so as to decrease a power consumption of the processing module. An electronic device equipped with such system may not only dynamically adjust the working frequency and/or the working voltage of the processing module, but also can determine a working frequency and/or a working voltage satisfying a report rate through an input of the system.

### CROSS-REFERENCE TO RELATED APPLICATIONS

This non-provisional application claims priority under 35 U.S.C. §119(a) on Patent Application No(s). 099139609 filed in Taiwan, R.O.C. on Nov. 17, 2010, the entire contents of which are hereby incorporated by reference.

### BACKGROUND OF THE INVENTION

1. Field of Invention

The present invention relates to a touch system and an optical touch system with a power-saving mechanism, and more particularly to a touch system and an optical touch system capable of dynamically adjusting a power consumption of a processing module.

2. Related Art

With the rapid development of electronic technologies, a computer equipment has been gradually evolved from a desk-top computer to a portable notebook computer, in which a display (for example, a screen) of the notebook computer has been developed from a conventional cathode ray tube (CRT) to a liquid crystal display (LCD), and even to an optical touch monitor (OTM). A touch panel is used as a communication interface between the computer equipment and a user, so that the user can directly touch the screen with a finger without additionally using an input device such as a keyboard or a mouse, so as to achieve the purpose of controlling the operation of electronic products.

In recent years, with the rise of environmental protection awareness and the innovation of computer information products, the concept of green products gradually affects the design idea of all the computer information products. The energy conservation of the touch panel naturally attracts considerable attention. Generally, due to the power saving ideas, the touch panel has the advantages that the stand-by time of the portable electronic device is prolonged, so the user does not need to charge the electronic device frequently, thus enhancing the convenience in use.

In a common touch system, the larger the count of touch points is, the higher the complexity of the corresponding algorithm is. Therefore, generally, in order to satisfy a report rate of the system, a designer must ensure that an execution frequency/voltage of a processor executing the algorithm satisfies the most complex algorithm, so in this case, power consumption of the system with less touch points is generally still the same as that with more touch points. Thus, not only much unnecessary power is consumed, but also such problems as that continuous power of the system cannot be prolonged are caused, thus resulting in a lot of inconveniences in use.

### SUMMARY OF THE INVENTION

Accordingly, the present invention is a touch system and an optical touch system with a power-saving mechanism, which solve the problems in the prior art.

The present invention provides a touch system, which has at least one touch region. The touch system comprises a sensing module and a processing module. The sensing module detects at least one indication object on the touch region, so as to output a detection result, and the detection result comprises at least one touch point count. The processing module is electrically connected to the sensing module, and executes a preset function according to the detection result. The processing module modulates a working frequency and/or a working voltage of the processing module according to the touch point count, so as to decrease a power consumption of the processing module.

According to the touch system of the present invention, the processing module down-modulates the working frequency and/or the working voltage of the processing module according to a delay tolerance value, so as to decrease the power consumption of the processing module.

According to the touch system of the present invention, the processing module consumes a sleep energy in a sleep status, and the processing module up-modulates the working frequency and/or the working voltage of the processing module according to the sleep energy, so as to decrease the power consumption of the processing module.

According to the touch system of the present invention, the processing module determines a level of complexity according to the touch point count, and modulates the working frequency and/or the working voltage of the processing module according to the level of complexity modulate, so as to decrease the power consumption of the processing module.

The present invention further provides a touch system, which has at least one touch region. The touch system comprises a sensing module and a processing module. The sensing module detects at least one indication object on the touch region, so as to output a detection result. The processing module is electrically connected to the sensing module, and executes a preset function according to the detection result. The processing module modulates a working frequency and/or a working voltage of the processing module according to the preset function, so as to decrease a power consumption of the processing module.

The present invention further provides an optical touch system, which has at least one touch region. The optical touch system comprises an optical sensing module and a processing module. The optical sensing module detects at least one indication object on the touch region, so as to output at least one image, and the image comprises an imaging count of the indication object. The processing module is electrically connected to the optical sensing module, and executes a preset function according to a detection result of the optical sensing module. The processing module modulates a working frequency and/or a working voltage of the processing module according to the imaging count of the indication object comprised by the image, so as to decrease a power consumption of the processing module.

According to the optical touch system of the present invention, the optical sensing module comprises an image sensor and a reflecting mirror. The imaging count of the indication object comprised by the at least one image comprises an imaging count obtained by detecting the indication object by the image sensor and an imaging count of a mirror image of the indication object obtained by detecting the reflecting mirror by the image sensor.

According to the optical touch system of the present invention, the optical sensing module comprises at least two image sensors, the imaging count of the indication object comprised by the at least one image is an imaging count of the indication object captured by the image sensors, and the at least one image comprises a shelter image formed by sheltering a light source by the indication object and/or a reflection image formed by reflecting the light source by the indication object.

Therefore, the touch system and the optical touch system according to the present invention are used to dynamically adjust the working frequency and/or the working voltage of the processing module, and determine a working frequency and/or a working voltage of the processing module satisfying a report rate through an input of the system, so as to effectively achieve the power-saving performance of the system.

### BRIEF DESCRIPTION OF THE DRAWINGS

The present invention will become more fully understood from the detailed description given herein below for illustration only, and thus are not limitative of the present invention, and wherein:

FIGS. 1A and 1B are a schematic structural view and a system architectural diagram of a touch system according to a first embodiment of the present invention respectively;

FIG. 2 is a system architectural diagram of an optical touch system according to a second embodiment of the present invention;

FIG. 3A is a system architectural diagram of the optical touch system in FIG. 2, of which an optical sensing module comprises an image sensor and a reflecting mirror; and

FIG. 3B is a system architectural diagram of the optical touch system in FIG. 2, of which an optical sensing module comprises at least two image sensors.

### DETAILED DESCRIPTION OF THE INVENTION

The detailed features and advantages of the present invention are described below in great detail through the following embodiments, the content of the detailed description is sufficient for those skilled in the art to understand the technical content of the present invention and to implement the present invention there accordingly. Based upon the content of the specification, the claims, and the drawings, those skilled in the art can easily understand the relevant objectives and advantages of the present invention.

The present invention provides a touch system with a power-saving mechanism. The touch system may adjust a power management mechanism according to a working environment of the system, for example, adjusting the power management mechanism according to an operation complexity of touch or characteristics of a preset function corresponding to a current touch operation. The adjustment of the power management mechanism may be to directly adjust a working frequency and/or a working voltage of a processor used by the touch system, so as to reduce power consumption at a low working load or maintain a sufficient execution speed at a high load.

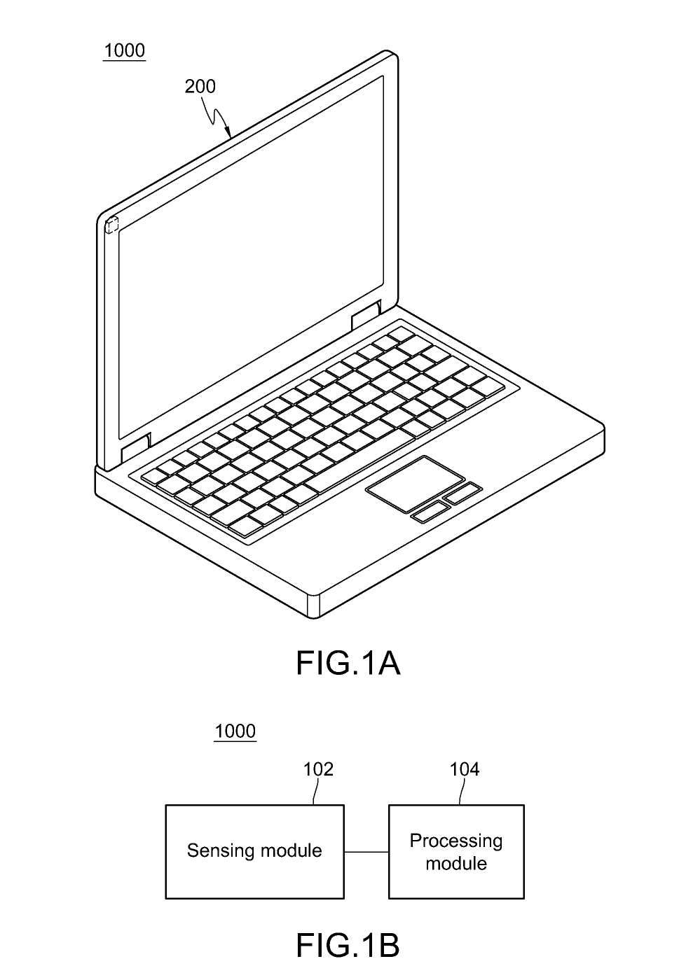

FIGS. 1A and 1B are a schematic structural view and a system architectural diagram of a touch system according to a first embodiment of the present invention respectively. The touch system is applicable to, but is not limited to be applied to, notebook computers, portable electronic equipments, communication equipments, or other electronic products. The application range of the touch system is not intended to limit the scope of the present invention, but only to illustrate the present invention. In the present invention, a touch system applied to a notebook computer is illustrated as an embodiment.

Referring to FIGS. 1A and 1B, a touch system 1000 comprises a sensing module 102 and a processing module 104, and the notebook computer is provided with at least one touch region 200 (for example, a panel), for a user to contact and control a computer equipment. The processing module 104 is electrically connected to the sensing module 102, and executes a preset function according to a detection result of the sensing module 102. Generally, the sensing module 102 may be an optical, a resistive, or a capacitive sensor, and is used to detect at least one indication object on the touch region 200. After detecting the indication object, the sensing module 102 may output a detection result accordingly. The detection result comprises at least one touch point count, and the touch point count is a total count of the indication object detected by the sensing module 102.

In the embodiment, the touch system 1000 determines a level of complexity according to the total count of the indication object detected by the sensing module 102, and then adjusts a power management mechanism according to the level of complexity. Particularly, referring to the following table, a comparison and reference diagram of determining the level of complexity according to the touch point count by the touch system according to the first embodiment of the present invention is shown.

| Level of complexity | Touch point count | Formation of information |
|---|---|---|
| 1 | 1 | |
| 2 | 2 | Easy to determine the touch |
| | | point region |
| 3 | 2 | Not easy to determine the |
| | | touch point region |
| 4 | 2 | Not easy to determine the |
| | | touch point region and |
| | | insufficient information, |
| | | gesture detection |
| 5 | 3 | Easy to determine the touch |
| | | point region |
| . . . | . . . | . . . |
| . . . | . . . | . . . |
| . . . | . . . | . . . |
| Cₓ | x | The highest complexity, |
| | | critical path of algorithm |

As shown in the table, when the indication object emerges on the touch region, and the touch point count is 1 (that is, single-point touch), a corresponding level of complexity is 1; when the indication object emerges on the touch region, the touch point count is 2 (that is, multiple-point touch), and it is easy to determine the region generated by the touch points, a corresponding level of complexity is 2; while when the indication object emerges on the touch region, the touch point count is 2, but it is not easy to determine the region generated by the touch points, a corresponding level of complexity is increased to be 3. Whether it is easy to determine the region generated by the touch points may be determined according to whether an image information result detected by the sensing module is sheltered by a shelter or whether an image is merged. Accordingly, the processing module 104 calculates a touch position of the indication object on the touch region according to the detection result of the sensing module 102, so as to execute the preset function, and the processing module 104 determines the level of complexity corresponding to the touch point count according to an emergence region of the indication object, whether it is easy to determine the region, and/or the touch point count detected by the sensing module 102.

Next, the processing module 104 calculates an execution time unit needed by an algorithm according to the level of complexity, that is, calculating an instruction cycle to be consumed by the processing module 104 through a transfer function et(Cₓ) when the level of complexity is Cₓ. Through the transfer function, the maximal instruction count needed by different levels of the complexity of the algorithm is statically analyzed, and then is converted into an instruction cycle in combination with processing characteristics of the processing module 104, or patterns of the different levels of the complexity of the algorithm are actually input, and an execution time (ms) needed is counted, and then is converted into an execution time unit according to a processing frequency/voltage of the processing module 104 at this time.

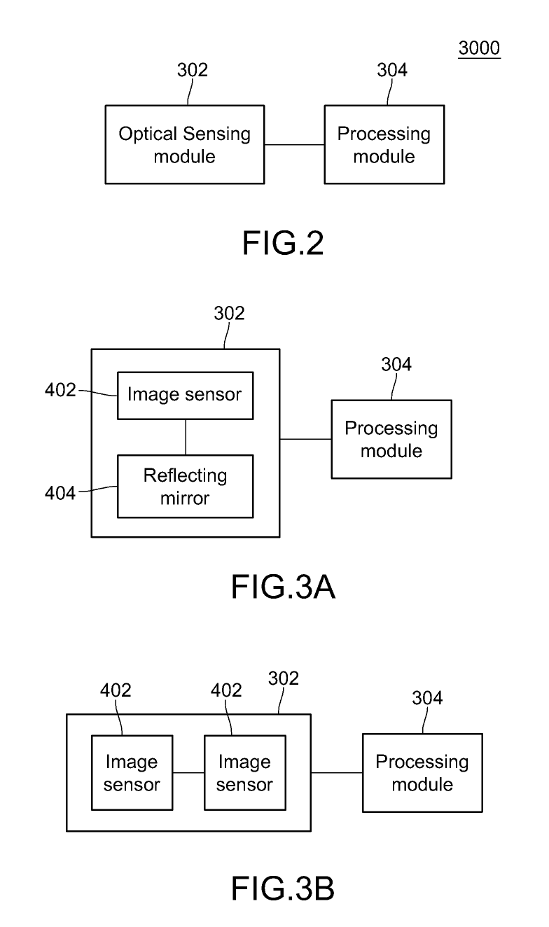

FIG. 2 is a system architectural diagram of an optical touch system according to a second embodiment of the present invention. The optical touch system is applicable to, but is not limited to be applied to, notebook computers, portable electronic equipments, communication equipments, or other electronic products. The application range of the optical touch system is not intended to limit the scope of the present invention, but only to illustrate the present invention. An optical touch system applied to a notebook computer is illustrates hereinafter as an embodiment.

An optical touch system 3000 comprises an optical sensing module 302 and a processing module 304, and the notebook computer is provided with at least one touch region (for example, a panel), for a user to contact and control the computer equipment. The processing module 304 is electrically connected to the optical sensing module 302, and executes a preset function according to a detection result of the optical sensing module 302. Generally, the optical sensing module 302 detects at least one indication object on the touch region, and outputs at least one image, and the image comprises an imaging count of the indication object.

Particularly, as shown in FIG. 3A, the optical sensing module 302 may comprise an image sensor 402 and a reflecting mirror 404. Thus, when the indication object emerges on the touch region, the imaging count of the indication object comprised in the image detected by the optical sensing module 302 comprises an imaging count obtained by detecting the indication object by the image sensor 402 and an imaging count of a mirror image of the indication object obtained by detecting the reflecting mirror 404 by the image sensor 402. For example, when the count of the indication object is one, the imaging count obtained by the image sensor 402 may be two; when the count of the indication object is two, the imaging count obtained by the image sensor 402 may be up to four.

Or, as shown in FIG. 3B, the optical sensing module 302 may comprise at least two image sensors 402. Thus, the imaging count of the indication object comprised in the image detected by the optical sensing module 302 is the imaging count of the indication object captured by each of the image sensors 402, and the image comprises: a shelter image formed by sheltering a light source by the indication object and/or a reflection image formed by reflecting the light source by the indication object. For example, when two image sensors 402 are arranged on the touch region (for example, a panel), although only one indication object emerges on the touch region, in a detection result of each of the two image sensors 402, the imaging count may be, for example, (1,1), (1,2), (2,1), and (2,2), in which coordinate values represent imaging counts of the indication object detected by the two image sensors 402 respectively.

Therefore, according to the optical touch system of the second embodiment of the present invention, after capturing the imaging counts detected by the optical sensing module 302 in two manners mentioned above, the processing module 304 determines a corresponding level of complexity according to the imaging counts, the emergence region of the indication object in the image, whether a mirror image exists, and/or whether it is easy to determine the region.

Then, the processing module 304 modulates a working frequency and/or a working voltage thereof according to the image count comprised in the image detected by the optical sensing module 302, so as to decrease a power consumption of the processing module 304.

As a response time to the touch and a touch count predicted for an operation may be different when functions executed by the touch system are different, therefore when the functions executed by the touch system are known, the working frequency and/or the working voltage of the processing module 304 is adjusted according to the characteristics of the executed functions. For example, the user directly sets a function to be executed, such as, a specific application program to be executed by the user, and the touch system adjusts the working frequency and/or the working voltage of the processing module 304 in advance according to the specific application program. The touch system may also directly adjust the working frequency and/or the working voltage of the processing module 304 according to the function executed by the system currently. Or, the touch system determines the function executed currently according to a current touch situation, for example, if the current touch situation conforms to a specific gesture, the function is determined to be a pose operation function, in which only the situation of relative movement of touch points needs to be determined without precisely positioning coordinates of the touch points, and thus the working frequency and/or the working voltage of the processing module 304 is decreased. The above examples are only used to illustrate but not intended to limit implementation aspects of the present invention, and the implementation aspects may also be used in coordination with each other to achieve a better power adjustment method.

Therefore, according to the embodiments, the processing module selectively modulates the preset function, the working frequency and/or the working voltage thereof according to the touch point count generated by the indication object in the touch system and/or the imaging count generated by the indication object in the optical touch system, or the function currently executed or to be executed, so as to decrease the power consumption of the processing module. The modulation may be implemented in a first to fourth policies below.

First: Conservative Policy

The processing module adjusts the working frequency and/or the working voltage thereof according to the current touch point count and/or the execution time corresponding to the imaging count, so as to decrease the power consumption.

Second: Application-Prediction Policy

The processing module predicts complexity of an algorithm required in the future according to the touch characteristics of the application program executed by the system currently, for example, a type of the application program input by the user in advance or automatically detected by the system, and then adjusts the processing module to the working frequency and/or the working voltage in the execution time corresponding to the complexity of executing the algorithm, so as to decrease the power consumption. In other words, the touch system adjusts the power management mechanism according to different application programs (for example, a program of moving the coordinates and a drawing program) of the preset function.

Third: Aggressive Policy

The processing module down-modulates the working frequency and/or the working voltage thereof according to a delay tolerance value, so as to decrease the power consumption. For example, the delay tolerance value may comprise an acceptable delay threshold and an acceptable delay length threshold. The acceptable delay threshold allows the processing module to reduce the working frequency and/or the working voltage as much as possible when a decrease extent of a report rate is lower than the threshold, so as to decrease the power consumption. However, the acceptable delay length threshold stops decreasing the working frequency and/or the working voltage when time during which the decrease extent of the report rate is lower than the acceptable delay threshold is restricted to be longer than the acceptable delay length threshold and increases the working frequency and/or the working voltage, so as to maintain the report rate of the processing module. The aggressive policy may have a power-saving effect better than the conservative policy due to the setting of the delay tolerance value.

Fourth: Sleep-Aggressive Policy

As the processing module consumes a sleep energy in a sleep status, the processing module up-modulates the working frequency and/or the working voltage as much as possible according to the sleep energy, and calculates the coordinate and the corresponding consumption energy with a high frequency, so as to reach the report rate required by the system, and to enable the processing module to enter sleep as soon as possible to achieve the power-saving effect. However, the sleep-aggressive policy needs to consider cooperation among sleep characteristics of the processing module, time during which the processing module enters sleep and recovers from the sleep status, and power consumption characteristics, so as to achieve a better power-saving effect.

In order to enhance the power-saving effect of the system, the aggressive policy and the sleep-aggressive policy may also be selectively executed in coordination with the conservative policy or the application-prediction policy, which all fall within the scope of the present invention.

Therefore, according to the touch system and the optical touch system of the present invention, the processing module modulates the working frequency and/or the working voltage thereof according to the preset function, the touch point count detected by the sensing module and/or the imaging count detected by the optical sensing module, so as to decrease the power consumption of the processing module, and to achieve the power-saving performance of the system. Secondly, in a preferred embodiment of the present invention, the processing module may further modulate the working frequency and/or the working voltage of the sensing module according to the preset function and/or the touch point count detected by the sensing module, so as to further improve the power-saving performance of the system.

Therefore, the touch system and the optical touch system according to the present invention are used to dynamically adjust the working frequency and/or the working voltage of the processing module, and determine a working frequency and/or a working voltage of the processing module satisfying a report rate through an input of the system, so as to effectively achieve the power-saving performance of the system.

What is claimed is:

1. A touch system with a power-saving mechanism having at least one touch region, comprising:
a sensing module, for detecting at least one indication object on the touch region, so as to output a detection result, wherein the detection result comprises at least one touch point count; and
a processing module, electrically connected to the sensing module, wherein the processing module executes a preset function according to the detection result;
wherein the processing module modulates a working frequency and/or a working voltage of the processing module according to the touch point count, so as to decrease a power consumption of the processing module.

2. The touch system with the power-saving mechanism according to claim 1, wherein the processing module down-modulates the working frequency and/or the working voltage of the processing module according to a delay tolerance value, so as to decrease the power consumption of the processing module.

3. The touch system with the power-saving mechanism according to claim 1, wherein the processing module consumes a sleep energy in a sleep status, and the processing module up-modulates the working frequency and/or the working voltage of the processing module according to the sleep energy, so as to decrease the power consumption of the processing module.

4. The touch system with the power-saving mechanism according to claim 1, wherein the processing module determines a level of complexity according to the touch point count, and modulates the working frequency and/or the working voltage of the processing module according to the level of complexity, so as to decrease the power consumption of the processing module.

5. The touch system with the power-saving mechanism according to claim 4, wherein the processing module determines the level of complexity according to an emergence region of the indication object and/or the touch point count detected by the sensing module.

6. The touch system with the power-saving mechanism according to claim 1, wherein the sensing module comprises one or more sensors, the detection result is generated by detecting the at least one indication object by the one or more sensors, the touch point count is a total count of detecting the at least one indication object by the one or more sensors, and the processing module calculates a touch position of the at least one indication object on the touch region according to the detection result, so as to execute the preset function.

7. The touch system with the power-saving mechanism according to claim 1, wherein the sensing module is an optical, a resistive, or a capacitive sensor.

8. The touch system with the power-saving mechanism according to claim 1, wherein the processing module further modulates a working frequency and/or a working voltage of the sensing module according to the touch point count.

9. A touch system with a power-saving mechanism having at least one touch region, comprising:
a sensing module, for detecting at least one indication object on the touch region, so as to output a detection result; and
a processing module, electrically connected to the sensing module, wherein the processing module executes a preset function according to the detection result;
wherein the processing module modulates a working frequency and/or a working voltage of the processing module according to the preset function, so as to decrease a power consumption of the processing module.

10. The touch system with the power-saving mechanism according to claim 9, wherein the processing module down-modulates the working frequency and/or the working voltage of the processing module according to a delay tolerance value, so as to decrease the power consumption of the processing module.

11. The touch system with the power-saving mechanism according to claim 9, wherein the processing module consumes a sleep energy in a sleep status, and the processing module up-modulates the working frequency and/or the working voltage of the processing module according to the sleep energy, so as to decrease the power consumption of the processing module.

12. The touch system with the power-saving mechanism according to claim 9, wherein the processing module determines a level of complexity according to the detection result output by the sensing module, and modulates the working frequency and/or the working voltage of the processing module according to the level of complexity, so as to decrease the power consumption of the processing module.

13. The touch system with the power-saving mechanism according to claim 12, wherein the processing module determines the level of complexity according to an emergence region of the indication object and/or at least one touch point count detected by the sensing module.

14. The touch system with the power-saving mechanism according to claim 9, wherein the sensing module comprises one or more sensors, the detection result is generated by detecting the at least one indication object by the one or more sensors, the touch point count is a total count of detecting the at least one indication object by the one or more sensors, and the processing module calculates a touch position of the at least one indication object on the touch region according to the detection result, so as to execute the preset function.

15. The touch system with the power-saving mechanism according to claim 9, wherein the sensing module is an optical, a resistive, or a capacitive sensor.

16. The touch system with the power-saving mechanism according to claim 9, wherein the processing module further modulates a working frequency and/or a working voltage of the sensing module according to the preset function.

17. An optical touch system with a power-saving mechanism having at least one touch region, comprising:
an optical sensing module, for detecting at least one indication object on the touch region, so as to output at least one image, wherein the at least one image comprises an imaging count of the indication object; and
a processing module, electrically connected to the optical sensing module, wherein the processing module executes a preset function according a detection result of the optical sensing module;
wherein the processing module modulates a working frequency and/or a working voltage of the processing module according to the imaging count of the indication object comprised by the at least one image, so as to decrease a power consumption of the processing module.

18. The optical touch system with the power-saving mechanism according to claim 17, wherein the processing module down-modulates the working frequency and/or the working voltage of the processing module according to a delay tolerance value, so as to decrease the power consumption of the processing module.

19. The optical touch system with the power-saving mechanism according to claim 17, wherein the processing module consumes a sleep energy in a sleep status, and the processing module up-modulates the working frequency and/or the working voltage of the processing module according to the sleep energy, so as to decrease the power consumption of the processing module.

20. The optical touch system with the power-saving mechanism according to claim 17, wherein the processing module determines a level of complexity according to a detection result output by the optical sensing module, and modulates the working frequency and/or the working voltage of the processing module according to the level of complexity, so as to decrease the power consumption of the processing module.

21. The optical touch system with the power-saving mechanism according to claim 20, wherein the processing module determines the level of complexity according to an emergence region of the indication object in the image and/or the imaging count of the indication object in the image.

22. The optical touch system with the power-saving mechanism according to claim 17, wherein the optical sensing module comprises an image sensor and a reflecting mirror, the imaging count of the indication object comprised by the at least one image comprises an imaging count obtained by detecting the indication object by the image sensor and an imaging count of a mirror image of the indication object obtained by detecting the reflecting mirror by the image sensor.

23. The optical touch system with the power-saving mechanism according to claim 17, wherein the optical sensing module comprises at least two image sensors, the imaging count of the indication object comprised by the at least one image is an imaging count of the indication object captured by the image sensors, and the at least one image comprises a shelter image formed by sheltering a light source by the indication object and/or a reflection image formed by reflecting the light source by the indication object.

24. The optical touch system with the power-saving mechanism according to claim 17, wherein the processing module further modulates a working frequency and/or a working voltage of the optical sensing module according to the preset function.
